(19) United States
(12) Patent Application Publication
(10) Pub. No.: US 2022/0361479 A1
(43) Pub. Date: Nov. 17, 2022

(54) Portable Hunting Blind Assembly

(71) Applicant: Carlie Reed, McIntosh, AL (US)

(72) Inventor: Carlie Reed, McIntosh, AL (US)

(21) Appl. No.: 17/319,448

(22) Filed: May 13, 2021

(51) Int. Cl. A01M 31/02; E04H 15/00

(52) U.S. Cl. CPC A01M 31/025; E04H 15/001

(57) ABSTRACT

A portable hunting blind assembly includes a plurality of tubes that is each positionable on a support surface having each of the tubes defining a respective corner of a rectangle. A plurality of spools is each rotatably integrated into a respective one of the tubes. Each of the spools is biased to rotate in a first direction and each of the spools is rotatable in a second direction. A plurality of screens is each coupled to a respective one of the spools. Each of the screens is drawable outwardly from the respective tube and each of the screens is releasably attachable to an adjacent one of the tubes when the screens are drawn outwardly from the respective tube.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to hunting blind devices and more particularly pertains to a new hunting blind device for facilitating a hunting blind to be set up in any location, including around an obstacle. The device includes a plurality of tubes, a plurality of spools positioned within each of the tubes and a plurality of screens that are attached to a respective spool. The screens are drawable outwardly from the respective tube and attachable to an adjacent tube to form a hunting blind.

### (2) Description of Related Art Including Information Disclosed Under 37 CFR 1.97 and 1.98

The prior art relates to hunting blind devices including a variety of hunting blinds which include a single panel that can be routed around a plurality of supports to define a hunting blind. The prior art discloses a variety of retractable barriers that includes a panel which can be drawn outwardly from a tube to define a barrier. The prior art also discloses a sand and wind barrier that includes a panel that can insertably receive a plurality of support rods for defining a sand and wind barrier.

### BRIEF SUMMARY OF THE INVENTION

An embodiment of the disclosure meets the needs presented above by generally comprising a plurality of tubes that is each positionable on a support surface having each of the tubes defining a respective corner of a rectangle. A plurality of spools is each rotatably integrated into a respective one of the tubes. Each of the spools is biased to rotate in a first direction and each of the spools is rotatable in a second direction. A plurality of screens is each coupled to a respective one of the spools. Each of the screens is drawable outwardly from the respective tube and each of the screens is releasably attachable to an adjacent one of the tubes when the screens are drawn outwardly from the respective tube.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a portable hunting blind assembly according to an embodiment of the disclosure.

FIG. 2 is a front phantom view of an embodiment of the disclosure.

FIG. 3 is a right side phantom view of an embodiment of the disclosure.

FIG. 4 is a left side view of an embodiment of the disclosure.

FIG. 5 is a top view of an embodiment of the disclosure.

FIG. 6 is a perspective view of an embodiment of the disclosure.

### DETAILED DESCRIPTION OF THE INVENTION

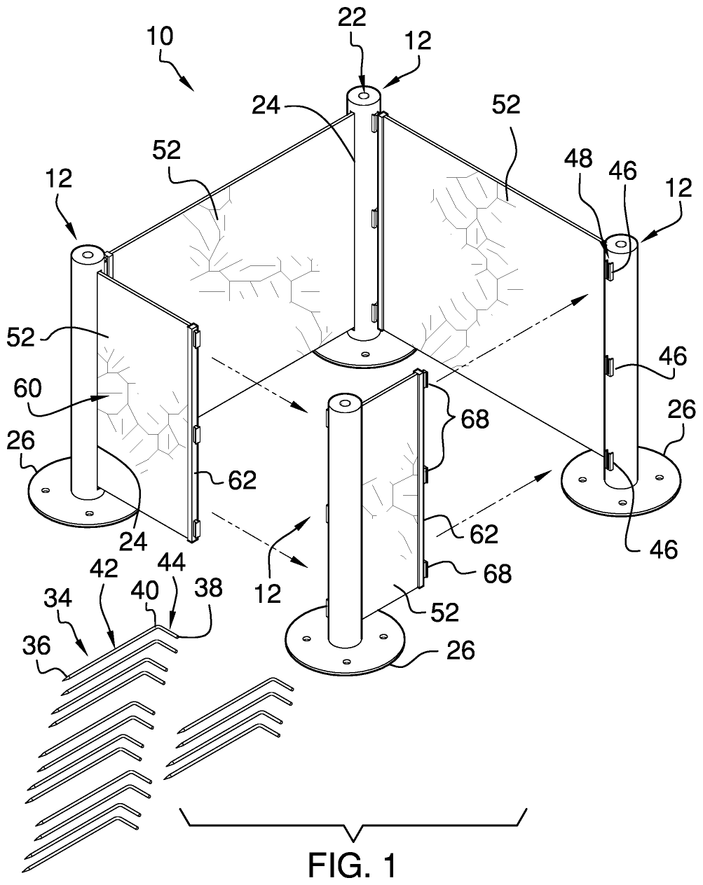

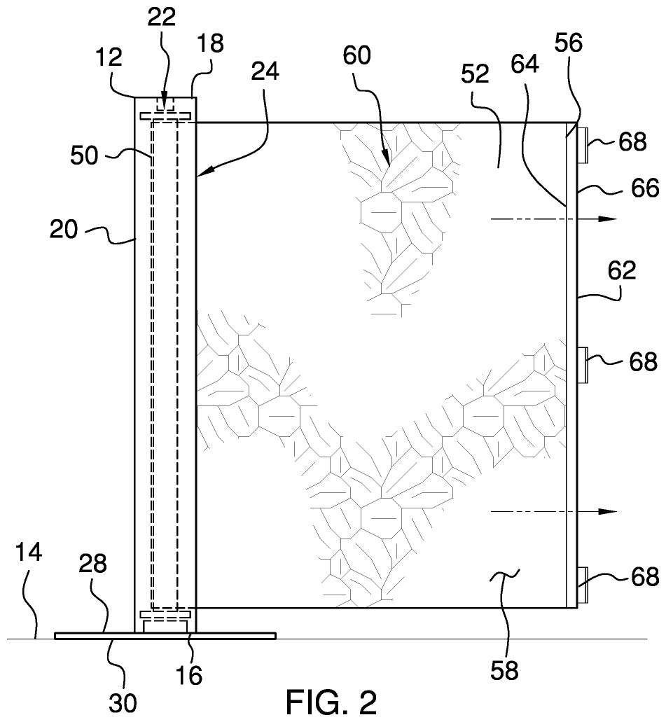

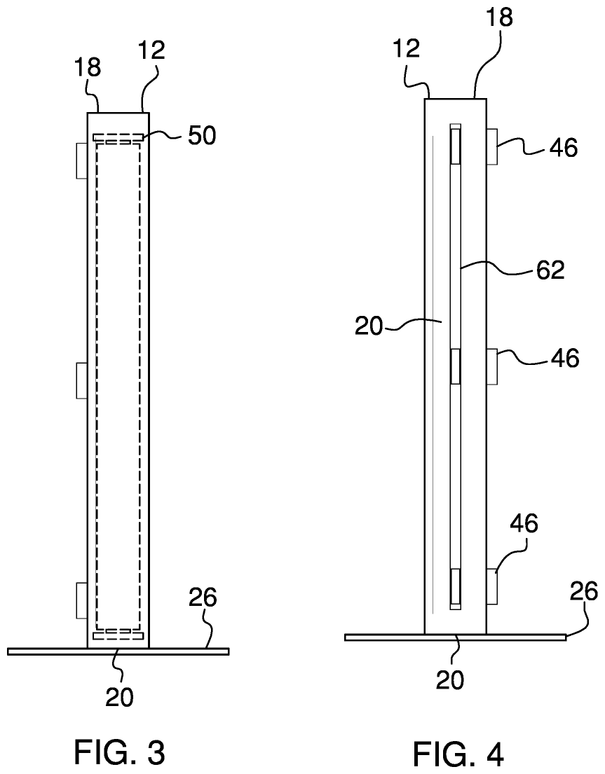

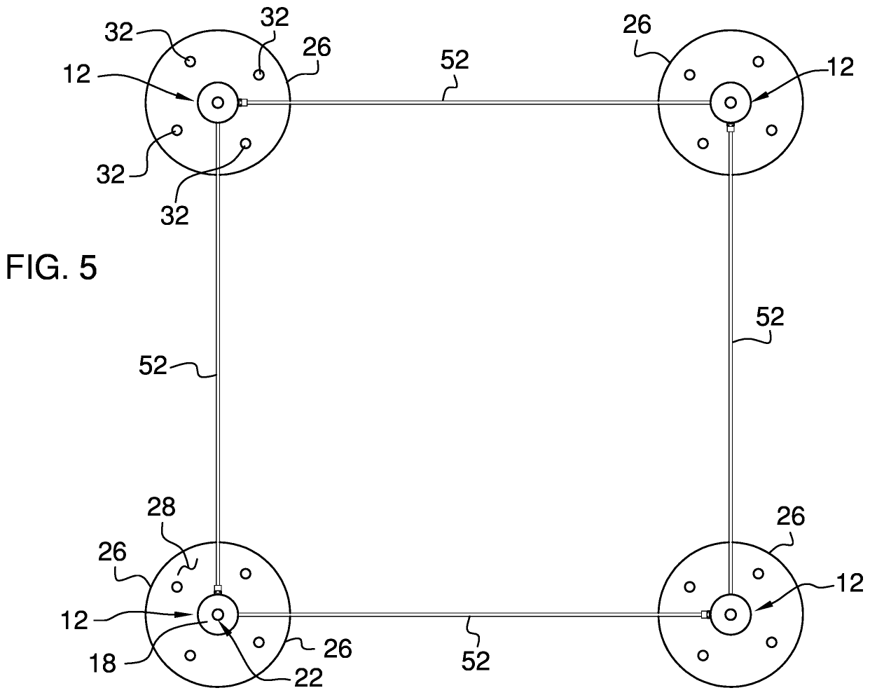

With reference now to the drawings, and in particular to FIGS. 1 through 6 thereof, a new hunting blind device embodying the principles and concepts of an embodiment of the disclosure and generally designated by the reference numeral 10 will be described.

As best illustrated in FIGS. 1 through 6, the portable hunting blind assembly 10 generally comprises a plurality of tubes 12 that is each positionable on a support surface 14 having each of the tubes 12 defining a respective corner of a rectangle. The support surface 14 each of the tubes 12 has a bottom end 16, a top end 18 and an outer wall 20 extending therebetween, and each of the top end 18 and the bottom end 16 of each of the tubes 12 is closed. The top end 18 of each of the tubes 12 has a well 22 extending toward the bottom end 16. Additionally, the outer wall 20 of each of the tubes 12 has a slot 24 extending into an interior of a respective tube 12 and the slot 24 in each of the tubes 12 extends substantially between the top end 18 and the bottom end 16.

A plurality of bases 26 is provided and each of the bases 26 is coupled to a respective one of the tubes 12. Each of the bases 26 rests on the support surface 14 to retain the tubes 12 in a vertical orientation on the support surface 14. Each of the bases 26 has a top surface 28 and a bottom surface 30, and the bottom end 16 of each of the tubes 12 is coupled to the top surface 28 of a respective one of the bases 26. Each of the bases 26 has a plurality of holes 32 each extending through the top surface 28 and the bottom surface 30.

A plurality of stakes 34 is provided and each of the stakes 34 is extendable through a respective one of the holes 32 in a respective one of the bases 26. In this way the stakes 34 can secure the bases 26 to the support surface 14. Each of the stakes 34 has a first end 36 and a second end 38, and the first end 36 of each of the stakes 34 tapers to a point to penetrate the ground. Each of the stakes 34 has a bend 40 thereon to define a first portion 42 forming an angle with a second portion 44. The second portion 44 of each of the stakes 34 rests upon the top surface 28 of the respective base 26 when the stakes 34 are extended through the respective holes 32.

A plurality of clips 46 is each coupled to a respective one of the tubes 12, and each of the clips 46 is positioned on the outer wall 20 of a respective one of the tubes 12. Additionally, each of the clips 46 has a channel 48 integrated therein. The clips 46 on each of the tubes 12 are spaced apart from each other and are distributed between the top end 18 and the bottom end 16 of the respective tube 12.

A plurality of spools 50 is each rotatably integrated into a respective one of the tubes 12. Each of the spools 50 is biased to rotate in a first direction and each of the spools 50 is rotatable in a second direction. Each of the spools 50 extends between the top end 18 and the bottom end 16 of the respective tube 12. Each of the spools 50 may comprise a spring loaded spool or other type of mechanism.

A plurality of screens 52 is provided and each of the screens 52 is coupled to a respective one of the spools 50. Each of the screens 52 is drawable outwardly from the respective tube 12 such that each of the screens 52 defines a respective one of four walls of a hunting blind 54 when the tubes 12 are arranged in the rectangle. Each of the screens 52 is releasably attachable to an adjacent one of the tubes 12 when the screens 52 are drawn outwardly from the respective tube 12. Conversely, each of the screens 52 is retracted into the respective tube 12 when the spool 50 to which each of the screens 52 is coupled rotates in the first direction. The spool 50 on which each of the screens 52 is coupled rotates in the second direction when the screen 52 is drawn outwardly from the respective tube 12.

Each of the screens 52 has a distal edge 56 with respect to the outer wall 20 of the respective tube 12 and an outwardly facing surface 58. The outwardly facing surface 58 of each of the screens 52 has indicia 60 printed thereon. The indicia 60 comprise camouflage to reduce visibility of the screens 52 when the screens 52 are drawn outwardly from the respective tube 12. The camouflage may comprise woodland camouflage, geometric camouflage or any other type camouflage commonly employed for hunting.

A plurality of members 62 is provided and each of the members 62 has a first surface 64 and a second surface 66. The first surface 64 of each of the members 62 is coupled to the distal edge 56 of a respective of the screens 52. The first surface of each of the members 62 abuts the outer wall 20 of a respective one of the tubes 12 when the spool 50 on which the respective screen 52 rotates in the first direction. In this way the members 62 inhibit the screens 52 from being fully retracted into the respective tubes 12.

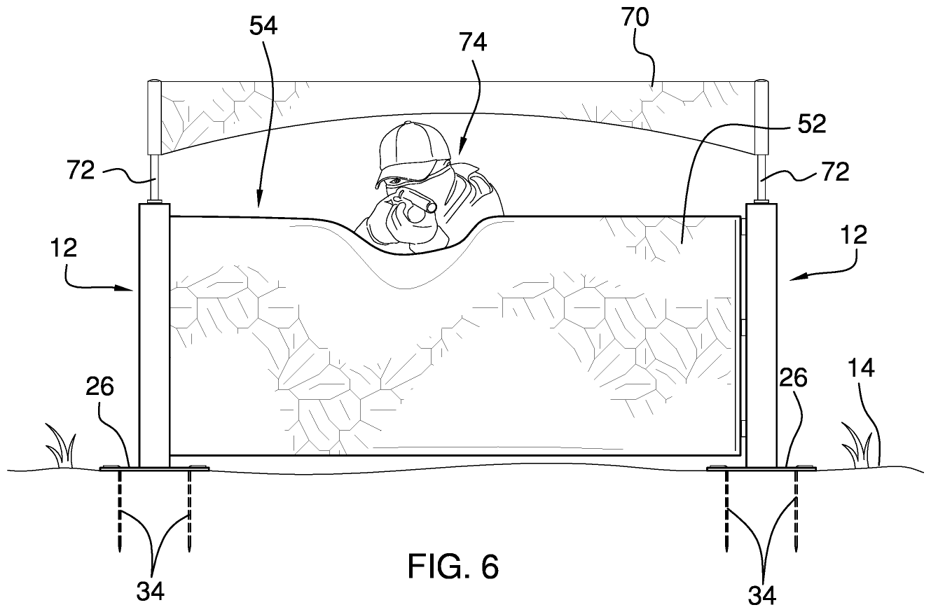

A plurality of engagements 68 is provided and each of the engagements 68 is coupled to the second surface of a respective one of the members 62. Each of the engagements 68 is slidable into the channel 48 in a respective one of the clips 46 on the outer wall 20 of a respective one of the tubes 12 for retaining the screens 52 extending between the plurality of tubes 12. Each of the engagements 68 may comprise a block that is slidable into the channel 48 in the respective member 62. As is most clearly shown in FIG. 6, a roof 70 might be provided that includes a plurality of poles 72. Each of the poles 72 can be inserted into the well 22 in the top end 18 of a respective one of the tubes 12. In this way the roof 70 can be supported over the area enclosed by the plurality of screens 52.

In use, the tubes 12 are arranged to define four corners of a rectangle in a location intended for hunting. Each of the screens 52 is drawn outwardly from the respective tube 12 and is secured to an adjacent tube 12. In this way the screens 52 define four walls of the hunting blind 54 in which a hunter 74 can position themselves for hunting. Moreover, the tubes 12 and the screens 52 facilitate the hunting blind 54 to be established around a tree or other obstacle that would prevent the use of a traditional, pre-constructed hunting blind. As is most clearly shown in FIG. 6, the roof 70 can be positioned over each of the tubes 12 to more thoroughly conceal the hunter 74 in the hunting blind 54 defined by the screens 52.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable hunting blind assembly for facilitating a hunting blind to be set up in any location, including around obstacles, said assembly comprising:
a plurality of tubes, each of said tubes being positionable on a support surface having each of said tubes defining a respective corner of a rectangle;
a plurality of bases, each of said bases being coupled to a respective one of said tubes wherein each of said bases is configured to rest on the support surface;
a plurality of spools, each of said spools being rotatably integrated into a respective one of said tubes, each of said spools being biased to rotate in a first direction, each of said spools being rotatable in a second direction; and
a plurality of screens, each of said screens being coupled to a respective one of said spools, each of said screens being drawable outwardly from said respective tube wherein each of said screens is configured to define a respective one of four walls of a hunting blind when said tubes are arranged in the rectangle, each of said screens being releasably attachable to an adjacent one of said tubes when said screens are drawn outwardly from said respective tube.

2. The assembly according to claim 1, wherein each of said tubes has a bottom end, a top end and an outer wall extending therebetween, each of said top end and said bottom end of each of said tubes being closed, said top end of each of said tubes having a well extending toward said bottom end, said outer wall of each of said tubes having a slot extending into an interior of a respective tube, said slot in each of said tubes extending substantially between said top end and said bottom end.

3. The assembly according to claim 2, wherein:
each of said bases has a top surface and a bottom surface, said bottom end of each of said tubes being coupled to said top surface of a respective one of said bases, each of said bases having a plurality of holes each extending through said top surface and said bottom surface; and
said assembly includes a plurality of stakes, each of said stakes being extendable through a respective one of said holes in a respective one of said bases wherein said stakes are configured to secure said bases to the support surface, each of said stakes having a first end and a second end, said first end of each of said stakes tapering to a point wherein said first end of each of said stakes is configured to penetrate the ground, each of said stakes having a bend thereon to define a first portion forming an angle with a second portion, said second portion of each of said stakes resting upon said top surface of said respective base when said stakes are extended through said respective holes.

4. The assembly according to claim 2, further comprising a plurality of clips, each of said clips being coupled to a respective one of said tubes, each of said clips being positioned on said outer wall of a respective one of said tubes, each of said clips having a channel being integrated therein, said clips on each of said tubes being spaced apart from each other and being distributed between said top end and said bottom end of said respective tube.

5. The assembly according to claim 1, wherein each of said screens is retracted into said respective tube when said spool to which each of said screens is coupled rotates in said first direction, said spool on which each of said screens is coupled rotating in said second direction when said screen is drawn outwardly from said respective tube, each of said screens having a distal edge with respect to said outer wall of said respective tube and an outwardly facing surface, said outwardly facing surface of each of said screens having indicia being printed thereon, said indicia comprising camouflage wherein said indicia is configured to reduce visibility of said screens when said screens are drawn outwardly from said respective tube.

6. The assembly according to claim 5, further comprising a plurality of members, each of said members having a first surface and a second surface, said first surface of each of said members being coupled to said distal edge of a respective of said screens, said first surface of each of said members abutting an outer wall of a respective one of said tubes when said spool on which said respective screen rotates in said first direction such that said members inhibit said screens from being fully retracted into said respective tubes.

7. The assembly according to claim 6, wherein:
each of said tubes has a bottom end, a top end and an outer wall extending therebetween, each of said top end and said bottom end of each of said tubes being closed, said top end of each of said tubes having a well extending toward said bottom end, said outer wall of each of said tubes having a slot extending into an interior of a respective tube, said slot in each of said tubes extending substantially between said top end and said bottom end;
said assembly includes a plurality of clips, each of said clips being coupled to a respective one of said tubes, each of said clips being positioned on said outer wall of a respective one of said tubes, each of said clips having a channel being integrated therein, said clips on each of said tubes being spaced apart from each other and being distributed between said top end and said bottom end of said respective tube; and
said assembly includes a plurality of engagements, each of said engagements being coupled to said second surface of a respective one of said members, each of said engagements being slidable into said channel in a respective one of said clips on said outer wall of a respective one of said tubes for retaining said screens extending between said plurality of tubes.

8. A portable hunting blind assembly for facilitating a hunting blind to be set up in any location, including around obstacles, said assembly comprising:
a plurality of tubes, each of said tubes being positionable on a support surface having each of said tubes defining a respective corner of a rectangle, each of said tubes having a bottom end, a top end and an outer wall extending therebetween, each of said top end and said bottom end of each of said tubes being closed, said top end of each of said tubes having a well extending toward said bottom end, said outer wall of each of said tubes having a slot extending into an interior of a respective tube, said slot in each of said tubes extending substantially between said top end and said bottom end;
a plurality of bases, each of said bases being coupled to a respective one of said tubes wherein each of said bases is configured to rest on the support surface, each of said bases having a top surface and a bottom surface, said bottom end of each of said tubes being coupled to said top surface of a respective one of said bases, each of said bases having a plurality of holes each extending through said top surface and said bottom surface;
a plurality of stakes, each of said stakes being extendable through a respective one of said holes in a respective one of said bases wherein said stakes are configured to secure said bases to the support surface, each of said stakes having a first end and a second end, said first end of each of said stakes tapering to a point wherein said first end of each of said stakes is configured to penetrate the ground, each of said stakes having a bend thereon to define a first portion forming an angle with a second portion, said second portion of each of said stakes resting upon said top surface of said respective base when said stakes are extended through said respective holes;
a plurality of clips, each of said clips being coupled to a respective one of said tubes, each of said clips being positioned on said outer wall of a respective one of said tubes, each of said clips having a channel being integrated therein, said clips on each of said tubes being spaced apart from each other and being distributed between said top end and said bottom end of said respective tube;
a plurality of spools, each of said spools being rotatably integrated into a respective one of said tubes, each of said spools being biased to rotate in a first direction, each of said spools being rotatable in a second direction, each of said spools extending between said top end and said bottom end of said respective tube;
a plurality of screens, each of said screens being coupled to a respective one of said spools, each of said screens being drawable outwardly from said respective tube wherein each of said screens is configured to define a respective one of four walls of a hunting blind when said tubes are arranged in the rectangle, each of said screens being releasably attachable to an adjacent one of said tubes when said screens are drawn outwardly from said respective tube, each of said screens being retracted into said respective tube when said spool to which each of said screens is coupled rotates in said first direction, said spool on which each of said screens is coupled rotating in said second direction when said screen is drawn outwardly from said respective tube, each of said screens having a distal edge with respect to said outer wall of said respective tube and an outwardly facing surface, said outwardly facing surface of each of said screens having indicia being printed thereon, said indicia comprising camouflage wherein said indicia is configured to reduce visibility of said screens when said screens are drawn outwardly from said respective tube;
a plurality of members, each of said members having a first surface and a second surface, said first surface of each of said members being coupled to said distal edge of a respective of said screens, said first surface of each of said members abutting said outer wall of a respective one of said tubes when said spool on which said respective screen rotates in said first direction such that said members inhibit said screens from being fully retracted into said respective tubes; and
a plurality of engagements, each of said engagements being coupled to said second surface of a respective one of said members, each of said engagements being slidable into said channel in a respective one of said clips on said outer wall of a respective one of said tubes for retaining said screens extending between said plurality of tubes.
